(19) United States
(12) Patent Application Publication
(10) Pub. No.: US 2025/0184414 A1
(43) Pub. Date: Jun. 5, 2025

(54) INTEGRATED STORAGE EXPANSION MOBILE PHONE CASE

(71) Applicant: Suzhou Kaixiang Technology Co., Ltd., Suzhou (CN)

(72) Inventor: Feiyue GU, Suzhou (CN)

(73) Assignee: Suzhou Kaixiang Technology Co., Ltd., Suzhou (CN)

(21) Appl. No.: 19/047,670

(22) Filed: Feb. 7, 2025

(30) Foreign Application Priority Data
Jan. 13, 2025 (CN) 202510052073.3

(51) Int. Cl. H04M 1/02

(52) U.S. Cl. CPC H04M 1/0203; H04M 1/0274

(57) ABSTRACT

An integrated storage expansion mobile phone case includes a mobile phone case body and a combined male-female connector, where a cavity for accommodating a mobile phone is provided at an interior of the mobile phone case body, a through hole is provided in a side wall of the mobile phone case body, and the position of the through hole is aligned with the position of a mobile phone charging port. The combined male-female connector passes through and is fixedly arranged in the through hole, with a male connector of the combined male-female connector being located at the interior of the mobile phone case body, and a female connector of the combined male-female connector being flush with an outer wall of the mobile phone case body. A memory chip, a current controller, and a circuit connector are embedded in the mobile phone case body close to the through hole.

### CROSS-REFERENCE TO RELATED APPLICATIONS

This application claims priority to Chinese Patent Application No. CN 202510052073.3, filed on Jan. 13, 2025. The content of the aforementioned application, including any intervening amendments thereto, is incorporated herein by reference.

### FIELD

The present application relates to the technical field of smartphone accessories, and particularly to an integrated storage expansion mobile phone case.

### BACKGROUND

As digital content proliferates, the demand for storage capacity among smartphone users is continuously increasing. However, due to limitations in internal space and cost considerations, the storage capacity of many smartphones cannot meet the long-term needs of users. The prior art provides various solutions, such as plug-in memory cards and external storage devices, but these solutions often require additional operations, which affect the user experience, and may cause damage to the interface or device due to frequent disassembly.

The patent document No. CN 107040636 A discloses a capacity expansion mobile phone case, which combines a storage expansion function with a charging function by adding a capacity expansion chip and multiple interfaces in the mobile phone case. However, the design of this technical solution is relatively complex, and the additional functions, such as the added headphone jack and USB interface, may impact the structural strength and practical operation convenience of the mobile phone case.

In summary, the storage expansion device of the existing capacity expansion mobile phone case is separate from the mobile phone case, requiring additional disassembly of the expansion module or interfering with the charging and data transfer functions of the mobile phone, leading to complex operation and poor user experience. Additionally, the storage module typically adopts ordinary storage technologies (for example, eMMC), with low transfer rates and high power consumption.

### SUMMARY

To this end, the present application provides an integrated storage expansion mobile phone case, to solve the problems of the separation of the mobile phone storage expansion device from the mobile phone case, complex operation, and influence on charging in the prior art.

To achieve the object hereinabove, the present application provides the following technical solution:

An integrated storage expansion mobile phone case includes a mobile phone case body and a combined male-female connector, where a cavity for accommodating a mobile phone is provided at an interior of the mobile phone case body, a through hole is provided in a side wall of the mobile phone case body, and the position of the through hole is aligned with the position of a mobile phone charging port; the combined male-female connector passes through and is fixedly arranged in the through hole, with a male connector of the combined male-female connector being located at the interior of the mobile phone case body, and a female connector of the combined male-female connector being flush with an outer wall of the mobile phone case body; a memory chip, a current controller, and a circuit connector are embedded in the end of the interior of the mobile phone case body close to the through hole, one end of the circuit connector is electrically connected to the memory chip and the current controller, the other end of the current controller is electrically connected to the memory chip, and the other end of the circuit connector is electrically connected to the combined male-female connector.

Preferably, the mobile phone case body is made of a rigid plastic or a composite material.

Preferably, the male connector of the combined male-female connector is a USB plug or a Lightning plug, and the female connector of the combined male-female connector is a USB interface or a Lightning interface.

Preferably, the USB plug is a Micro-B plug or a Type-C plug, and the USB interface is a Micro-B interface or a Type-C interface.

Preferably, the memory chip is a UFS memory chip.

Preferably, the memory chip has a capacity ranging from 128 GB to 1 TB.

Preferably, the combined male-female connector, the memory chip, the current controller, and the circuit connector are each integrally formed on the mobile phone case body.

Preferably, the current controller is an integrated IC module.

Compared with the prior art, the present application has at least the following advantageous effects:

1. The present application provides an integrated storage expansion mobile phone case, including a mobile phone case body and a combined male-female connector, where a cavity for accommodating a mobile phone is provided inside the mobile phone case body, a through hole is provided in a side wall of the mobile phone case body, and the position of the through hole is aligned with the position of a mobile phone charging port; the combined male-female connector passes through and is fixedly arranged in the through hole, with a male connector of the combined male-female connector being located at the interior of the mobile phone case body, and a female connector of the combined male-female connector being flush with an outer wall of the mobile phone case body; a memory chip, a current controller, and a circuit connector are embedded in the end of the interior of the mobile phone case body close to the through hole, one end of the circuit connector is electrically connected to the memory chip and the current controller, the other end of the current controller is electrically connected to the memory chip, and the other end of the circuit connector is electrically connected to the combined male-female connector. The integrated storage expansion mobile phone case provided by the present application integrates the storage expansion device at the interior of the mobile phone case, enabling the expansion of the storage capacity of the mobile phone without affecting its normal charging, and featuring a simple overall structure and ease of use.

2. The memory chip is a UFS memory chip, with a fast transfer rate and low power consumption.

### BRIEF DESCRIPTION OF THE DRAWINGS

To illustrate the prior art and the present application more visually, exemplary drawings are provided below. It is to be understood that the specific shapes and structures shown in the drawings are generally not considered as limiting conditions for the implementation of the present application. For example, based on the technical concepts and exemplary drawings disclosed in the present application, those skilled in the art can easily make routine adjustments or further optimizations to the addition/reduction/attribution division, specific shapes, positional relationships, connection methods, dimensional ratios, and the like of certain units (components).

FIG. 1 is an overall structural diagram of an integrated storage expansion mobile phone case provided by the present application;

FIG. 2 is a partial structural diagram of an integrated storage expansion mobile phone case provided by the present application; and

FIG. 3 is a partial structural diagram of the connection between an integrated storage expansion mobile phone case provided by the present application and a mobile phone interface.

### DESCRIPTION OF REFERENCE NUMERALS

1, mobile phone case body; 101, through hole; 2, combined male-female connector; 201, male connector of combined male-female connector; 202, female connector of combined male-female connector; 3, memory chip; 4, current controller; 5, circuit connector; and 6, mobile phone.

### DETAILED DESCRIPTION OF THE EMBODIMENTS

The present application is further described below in detail through specific embodiments with reference to the drawings.

In the description of the present application, “a plurality of” means two or more, unless otherwise specified. The terms “first”, “second”, “third”, and the like in the present application are intended to distinguish between the referenced objects and do not carry any special significance in the technical connotation (e.g., the terms shall not be construed as indicating importance or order, etc.). The expressions such as “comprise”, “include”, “have”, and the like further mean “include but not limited to” (certain units, components, materials, steps, etc.).

The reference to the terms such as “upper”, “lower”, “left”, “right”, “middle”, and the like in the present application is generally intended to indicate relative positional relationships for an intuitive understanding with reference to the drawings, and are not intended to impose an absolute limitation on the positional relationships in the actual product.

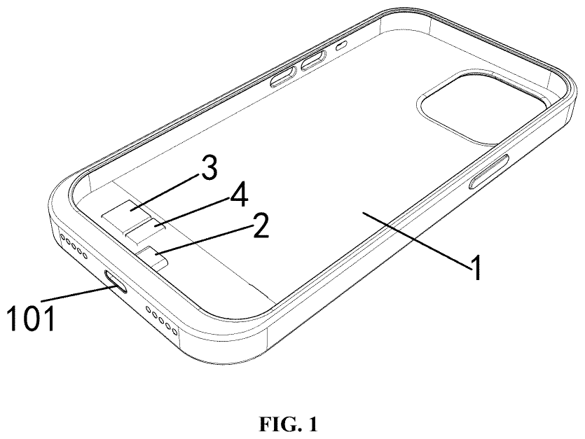

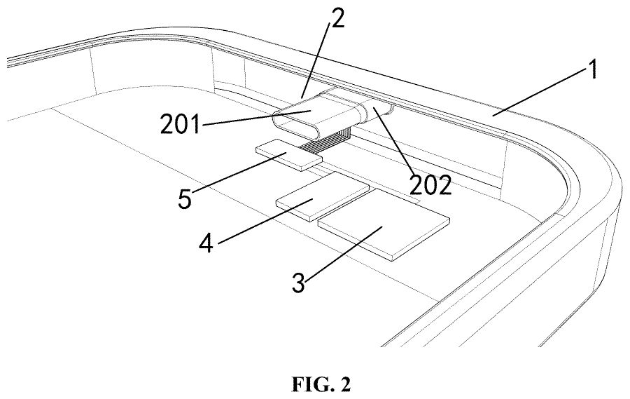

Referring to FIGS. 1 and 2, the present application provides an integrated storage expansion mobile phone case, including a mobile phone case body 1 and a combined male-female connector 2, where a cavity for accommodating a mobile phone is provided at an interior of the mobile phone case body 1, a through hole 101 is provided in a side wall of the mobile phone case body 1, and the position of the through hole 101 is aligned with the position of a mobile phone charging port; the combined male-female connector 2 passes through and is fixedly arranged in the through hole 101, with a male connector 201 of the combined male-female connector being located at the interior of the mobile phone case body 1, and a female connector 202 of the combined male-female connector being flush with an outer wall of the mobile phone case body 1; a memory chip 3, a current controller 4, and a circuit connector 5 are embedded in the end of the interior of the mobile phone case body 1 close to the through hole 101, one end of the circuit connector 5 is electrically connected to the memory chip 3 and the current controller 4, the other end of the current controller 4 is electrically connected to the memory chip 3, and the other end of the circuit connector 5 is electrically connected to the combined male-female connector 2.

In particular, the main function of the mobile phone case body 1 is to protect the mobile phone from external impacts, scratches, dust, and other damage, while also improving the appearance and hand feeling of the mobile phone. Therefore, the present application provides an integrated storage expansion mobile phone case, where the mobile phone case body 1 is made of a rigid plastic or a composite material.

The rigid plastic exhibits strong compression resistance and scratch resistance. Common rigid plastic materials include polycarbonate (PC) and polypropylene (PP), and the like. PC is a high-strength plastic that has good impact resistance and is capable of effectively absorbing external forces to protect the mobile phone from damage. Additionally, the PC material has excellent heat resistance and transparency, not only making it durable but also maintaining the original appearance of the mobile phone. PP is a lightweight, durable plastic with good toughness and wear resistance, and is commonly used to produce simple, lightweight mobile phone cases.

Composite materials are typically formed by combining two or more different materials through a specific process, making full use of the advantages of each material and making up for the shortcomings of a single material. Common composite materials include silicone and rigid plastic composites, carbon fiber composite materials, and aluminum alloy composite materials. The silicone and rigid plastic composites are commonly used in flexible-and-rigid mobile phone cases. The silicone part provides better anti-slip and shock absorption, while the rigid plastic part enhances the structural strength and impact resistance of the mobile phone case. The carbon fiber composite materials offer extremely high strength, heat resistance, and compression resistance, making mobile phone cases made of this material very light, thin, and sturdy, and thus effectively protecting the mobile phone from impact without adding excessive weight. The aluminum alloy composite materials are widely used in mobile phone cases, providing both good impact resistance and effective heat dissipation. Mobile phone cases made of the aluminum alloy composite materials typically feature a high-quality feel and a metallic luster.

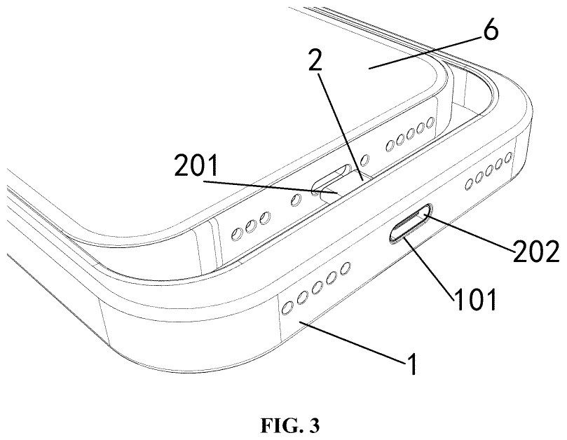

In particular, in the integrated storage expansion mobile phone case provided by the present application, the combined male-female connector 2 features an integrated design. The male connector 201 of the combined male-female connector is configured to connect to the charging port of the mobile phone 6, and as shown in FIG. 3, the female connector 202 of the combined male-female connector is configured to connect to a charger of the mobile phone 6, such that the storage capacity of the mobile phone 6 is expanded without affecting its normal charging, and without other additional functions.

More particularly, the male connector 201 of the combined male-female connector may be a USB or Lightning plug or the like, and correspondingly, the female connector 202 of the combined male-female connector may be a USB or Lightning interface or the like. The USB plug may be a Micro-B or Type-C plug or the like, and correspondingly, the USB interface may be a Micro-B or Type-C interface or the like, making it compatible with all mobile phones of different models currently available on the market.

In particular, in the integrated storage expansion mobile phone case provided by the present application, the memory chip 3 is a universal flash storage (UFS) memory chip, supporting fast storage and reading functions (at a read speed of 2100 MB/s and a write speed of 1200 MB/s), ensuring that the data transfer speed exceeds 800 MB/s, thereby meeting the requirements for high-performance storage. The memory chip has a capacity ranging from 128 GB to 1 TB, preferably of 256 GB. In the present application, the memory chip 3 is electrically connected to the male connector 201 of the combined male-female connector through the current controller 4, and then connected to the mobile phone 6. After the mobile phone case is connected to the charging port of the mobile phone 6, the memory chip 3 communicates with the mobile phone via a data transfer protocol to achieve the storage expansion function.

In particular, in the integrated storage expansion mobile phone case provided by the present application, the current controller 4 can dynamically adjust the direction and intensity of the current in the circuit, ensuring the stability of both the storage expansion and mobile phone charging functions, and ensuring that the charging efficiency of the mobile phone is not affected while the storage is expanded. At the same time, the current controller 4 is an integrated IC module, further reducing the size of the expansion component, making the mobile phone case thinner and lighter, and improving the user's grip.

In the integrated storage expansion mobile phone case provided by the present application, the combined male-female connector 2, the memory chip 3, the current controller 4, and the circuit connector 5 are each integrally formed on the mobile phone case body 1 using an integrated circuit design to ensure seamless connection and data transfer with the mobile phone. The design not only expands the storage capacity of the mobile phone but also maintains the charging function without affecting the normal use of the mobile phone. Additionally, the design simplifies the operation process and improves the user experience.

It is to be noted that the memory chip 3, the current controller 4, and the circuit connector 5 adopt a modular packaging design, facilitating the maintenance and replacement of the memory chip 3.

The integrated storage expansion mobile phone case provided by the present application has the following advantages:

1. Simple structure: The present application not only expands the storage capacity of the mobile phone without affecting the charging function, but also reduces additional interfaces and functions (for example, the integration of non-core functions like a headphone jack and a sliding USB interface, etc.), thereby improving the overall design compactness and reliability.

2. Optimized structure: By embedding the female connector of the combined male-female connector into the case, the external interfaces are reduced, leading to improved structural integrity and aesthetics, and improved product durability.

3. Ease of use: By means of the integrated molding design of the mobile phone case, users can expand the storage simply by inserting the mobile phone, without any additional operations.

4. Strong compatibility: The interface layout is designed to be consistent with that of mainstream smartphones, ensuring that charging operations are unaffected, and providing good user experience.

5. Optimized cost: By streamlining the functions, the manufacturing cost is lowered, while the market competitiveness of the product is improved.

The technical features of the embodiment hereinabove may be combined arbitrarily as long as there is no contradiction in the combination of these features. For the brevity of description, not all possible combinations of the technical features in the embodiment hereinabove are described, and those embodiments not mentioned explicitly shall also be considered to fall within the scope as set forth in this specification.

What is claimed is:

1. An integrated storage expansion mobile phone case, comprising a mobile phone case body and a combined male-female connector, wherein a cavity for accommodating a mobile phone is provided at an interior of the mobile phone case body, a through hole is provided in a side wall of the mobile phone case body, and the position of the through hole is aligned with the position of a mobile phone charging port; the combined male-female connector passes through and is fixedly arranged in the through hole, with a male connector of the combined male-female connector being located at the interior of the mobile phone case body, and a female connector of the combined male-female connector being flush with an outer wall of the mobile phone case body; a memory chip, a current controller, and a circuit connector are embedded in the end of the interior of the mobile phone case body close to the through hole, one end of the circuit connector is electrically connected to the memory chip and the current controller, the other end of the current controller is electrically connected to the memory chip, and the other end of the circuit connector is electrically connected to the combined male-female connector.

2. The integrated storage expansion mobile phone case according to claim 1, wherein the mobile phone case body is made of a rigid plastic or a composite material.

3. The integrated storage expansion mobile phone case according to claim 1, wherein the male connector of the combined male-female connector is a USB plug or a Lightning plug, and the female connector of the combined male-female connector is a USB interface or a Lightning interface.

4. The integrated storage expansion mobile phone case according to claim 3, wherein the USB plug is a Micro-B plug or a Type-C plug, and the USB interface is a Micro-B interface or a Type-C interface.

5. The integrated storage expansion mobile phone case according to claim 1, wherein the memory chip is a UFS memory chip.

6. The integrated memory expansion mobile phone case according to claim 1, wherein the memory chip has a capacity ranging from 128 GB to 1 TB.

7. The integrated storage expansion mobile phone case according to claim 1, wherein the combined male-female connector, the memory chip, the current controller, and the circuit connector are each integrally formed on the mobile phone case body.

8. The integrated storage expansion mobile phone case according to claim 1, wherein the current controller is an integrated IC module.
